(19) United States
(12) Patent Application Publication
(10) Pub. No.: US 2024/0152326 A1
(43) Pub. Date: May 9, 2024

(54) MEMORY DEVICE AND OPERATING METHOD THEREOF

(71) Applicant: Taiwan Semiconductor Manufacturing Company, Ltd., Hsinchu (TW)

(72) Inventors: Win-San Khwa, Taipei City (TW); Meng-Fan Chang, Taichung City (TW); Jui-Jen Wu, Hsinchu (TW); Chuan-Jia Jhang, Taichung City (TW)

(73) Assignee: Taiwan Semiconductor Manufacturing Company, Ltd., Hsinchu (TW)

(21) Appl. No.: 18/163,877

(22) Filed: Feb. 3, 2023

Related U.S. Application Data
(60) Provisional application No. 63/423,058, filed on Nov. 7, 2022.

(51) Int. Cl. G06F 7/544; G11C 7/06; G11C 7/10; H04L 9/08

(52) U.S. Cl. CPC G06F 7/5443; G11C 7/06; G11C 7/1096; H04L 9/0838

(57) ABSTRACT

A memory device includes a memory array, a multiply-accumulate (MAC) circuit and an encoder-decoder circuit. The MAC circuit performs a MAC operation on an encoded weight data stored in the memory array and an input data to generate a partial MAC result. An encoder of the encoder-decoder circuit is configured to encode m weight bits among n weight bits of weight data according to an encryption key to generate the encoded weight data, wherein m and n are positive integers, and m is less than n. A decoder of the encoder-decoder circuit is configured to detect an error in the partial MAC result according to the encryption key to generate a decoded partial MAC result.

### CROSS-REFERENCE TO RELATED APPLICATION

This application claims the priority benefit of U.S. provisional application Ser. No. 63/423,058, filed on Nov. 7, 2022. The entirety of the above-mentioned patent application is hereby incorporated by reference herein and made a part of this specification.

### BACKGROUND

Neural network and artificial intelligence (AI) algorithms have been widely used in many. AI applications and devices such as computers, computing devices and autonomous vehicles. A multiply-accumulate (MAC) operation is intensively performed in the AI applications, and error correction code (ECC) may be also implemented in the AI applications to protect data. However, since the existed ECC protects individual weight bits rather than a MAC result, the existed ECC is incompatible for AI accelerator that focuses on computing MAC operation. In addition, typical computations performed in the AI applications have asymmetric importance, and the existed ECC does not take this into consideration and protects all bits equally. Furthermore, a large area of an ECC encoder and an ECC decoder is another problem to be considered.

It is desirable for a creative design of a memory device that is capable of protecting a MAC result of a MAC operation, selectively protecting selected bits among a plurality of bits, and occupying a small area.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic diagram of a memory device in accordance with some embodiments.

FIG. 2 illustrates a schematic diagram of an encoder-decoder circuit of a memory device in accordance with some embodiments.

FIG. 3 illustrates a flowchart diagram of an encoding process in a memory device in accordance with some embodiments.

FIG. 4 illustrates a flowchart diagram of a decoding process in a memory device in accordance with some embodiments.

FIG. 5 illustrates a flowchart diagram of and operating method of a memory device in accordance with some embodiments.

### DESCRIPTION OF THE EMBODIMENTS

The following disclosure provides many different embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed,

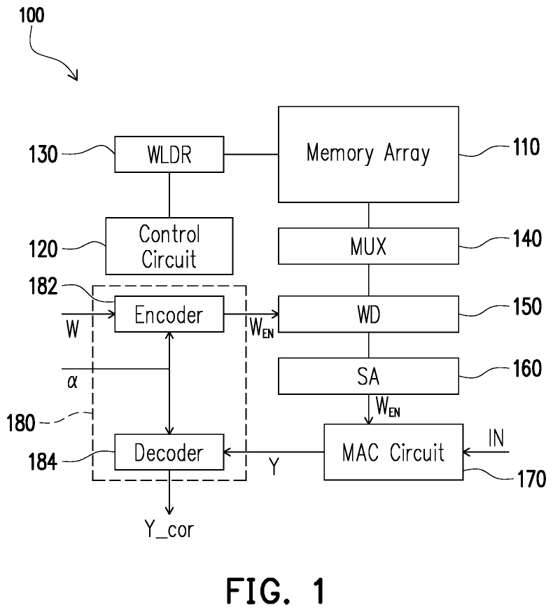

FIG. 1 illustrates a schematic diagram of a memory device 100 in accordance with some embodiments. The memory device 100 may include a memory array 110, a control circuit 120, a word line driver 130, a multiplexer 140, a write driver 150, a sense amplifier 160, a multiply-accumulate (MAC) circuit 170 and an encoder-decoder circuit 180. The memory array 110 may include a plurality of memory cells (not shown), a plurality of word lines (not shown), a plurality of bit lines (not shown), and a plurality of source lines (not shown). The word lines, the bit lines and the source lines are coupled to the memory cells of the memory array 110, and a memory operation (i.e., a read operation or a write operation) is performed on the memory cells to read data from the memory cells or to write data to the memory cells.

The control circuit 120 may include a word line decoder (not shown), a bit line decoder (not shown) and a timing controller (not shown). The word line decoder (also referred to as an X decoder) is configured to select at least one word line among the word lines of the memory array 110 for the memory operation (i.e., the read operation or the write operation). The bit line decoder (also referred to as an Y decoder) is configured to select at least one bit line among the bit lines of the memory array 110 for the memory operation. The timing controller may control timings for the memory operation. As such, the control circuit 120 may control the memory operation performed on the memory cells of the memory array 110.

The word line driver 130 is coupled to the memory array 110 and the control circuit 120, and the word line driver 130 is configured to drive the selected word line of the memory array 110 for the memory operation. The selected word line may be selected by the word line decoder of the control circuit 120. The multiplexer 140 is coupled to the memory array 110 and the control circuit 120, and the multiplexer 140 is configured to drive the selected bit line of the memory array 110 for the memory operation. The multiplexer 140 may select the selected bit line based on a decoding signal outputted from the bit line decoder of the control circuit 120.

The write driver 150 is coupled to the multiplexer 140 and is configured to write data to the memory array 110 via the selected bit line in the write operation. In some embodiments, the write driver 150 is configured to receive an encoded weight data W_{EN} from the encoder-decoder circuit 180 and write the encoded weight data W_{EN} to the memory array 110. The sense amplifier 160 is coupled to the memory array 110 and is configured to read the data stored in the memory array 110 in the read operation. In some embodiments, the sense amplifier 160 reads the encoded weight data W_{EN} and outputs the encoded weight data W_{EN} to the MAC circuit 170.

The MAC circuit 170 is coupled to the sense amplifier 160 and the encoder-decoder circuit 180. The MAC circuit 170 may receive an input data IN and the encoded weight data W_{EN}, and the MAC circuit 170 is configured to perform the MAC operation on the input data IN and the encoded weight data W_{EN} to generate a partial MAC result Y. The MAC circuit 170 may output the partial MAC result Y to the encoder-decoder circuit 180 for detecting an error in the partial MAC result Y. The encoder-decoder circuit 180 may correct the error in the partial MAC result Y when the error is detected.

The encoder-decoder circuit 180 may include an encoder 182 (also referred to as an ECC encoder) and a decoder 184 (also referred to as an ECC decoder). The encoder 182 is configured to receive the weight data W and encode a portion of the weight data W (weight data subset W_{U} including m upper weight bits of the weight data W) according to the encryption key α. The encoder 182 may generate at least one parity bit P_{U} based on the weight data subset W_{U}, and combine the weight data subset W_{U} and the parity bit P_{U} to generate a union [W_{U}|P_{U}] of the weight data subset W_{U} and the data bit P_{U}. The encoder 182 may encode the union [W_{U}|P_{U}] according to the encryption key α to generate the encoded weight data W_{EN}.

The m weight bits of the weight data subset W_{U} may be m most significant weight bits of the weight data W. In some embodiments, the encoder 182 encodes the m upper weight bits of the weight data W according to the encryption key α, and the encoder 182 does not encode the (n−m) subsequent weight bits (also referred to as lower weight bits) of the of the weight data W according to the encryption key α. The n−m lower weight bits are less important than the m upper weight bits of the weight data W. In other words, the encoder 182 may not encode all individual weight bits of the weight data W equally. Instead, the encoder 182 may prioritize encoding important weight bits (m upper weight bits) of the weight data W according to the encryption key α to protect the important weight bits of the weight data W. The encoder 182 may output the encoded weight data W_{EN} to the write driver 150 to write the encoded weight data W_{EN} to the memory array 110. Since the m upper weight bits of the weigh data W are protected, the partial MAC result Y that is calculated according to the encoded weight data W_{EN} is also protected.

In some embodiments, the encoder 182 is configured to encode the weight data subset W_{U} into the union [W_{U}|P_{U}] such that the modulo operation performed on the union [W_{U}|P_{U}] and the encryption key is equal to zero. In some embodiments, the encoding operation of the encoder 182 is performed to satisfy the expression (1), in which MOD is the modulo operation, [W_{U}|P_{U}] is the union of the weight data subset W_{U} and the parity bit P_{U}, α^{T} is a transpose of the encryption key α, a heavy dot (·) represents a dot product operation, and an operator≡represents an equality in value. As shown the expression (1), [W_{U}|P_{U}]·α^{T} is a dividend, N is the divisor, 0 in the right-hand side of the expression (1) is the remainder, and N is equal to 2*n+1, in which n is a bit width of the union [W_{U}|P_{U}]. In an example, when a bit width of the weight data subset W_{U} is 10 bits and a bit width of the parity bit P_{U} is 5 bits, the bit width of the union [W_{U}|P_{U}] is 15 bits, and the divisor N will be 31. It is noted that the bit widths of the weight data subset W_{U} and the bit width of the parity bit P_{U} are not limited in the disclosure and are determined according to design requirements.

[WU|PU]·αT MOD N≡0 (1)

Because the encoded weight data W_{EN} is used by the MAC circuit 170 to calculate the partial MAC result Y, the calculation of the partial MAC result Y satisfies the expression (2), in which MOD is the modulo operation, [W_{U}|P_{U}] is the union of the weight data subset W_{U} and the parity bit P_{U}, IN represents the input data, α^{T} is the transpose of the encryption key α, and heavy dot (·) represents a dot product operation. As shown in the expression (2), N·[WU|PU]·αT is a dividend, N is the divisor, and 0 in the right-hand side of the expression (2) is the remainder. N is equal to 2*n+1, in which n is a bit width of the union [W_{U}|P_{U}]

IN·[WU|PU]·α^{T} MOD N≡0 (2)

It is noted that the relationship represented in the expression (2) still hold for signed input data±IN and the singed union±[W_{U}|P_{U}]. In some embodiments, the decoder 184 of the encoder-decoder circuit 180 receives the partial MAC result Y and the encryption key α, and the decoder 184 is configured to detect the error in the partial MAC result Y according to the encryption key α to generate a decoded partial MAC result Y_cor. The decoder 184 may detect the error in the partial MAC result Y by performing a modulo operation on the partial MAC result Y and the transpose of the encryption key α^{T}. In some embodiments, the decoder 184 may detect the error in the partial MAC result Y based on the remainder (or the result of the modulo operation) of IN·[WU|PU]·αT MOD N. When the result of the modulo operation performed by the decoder 184 is equal to zero, there is no error occurred in the partial MAC result Y. When the remainder (or the result of the modulo operation) performed by the decoder 184 is a non-zero value, there is the error e occurred in the partial MAC result Y. Expression (3) illustrates an exemplary result of the modulo operation performed by the decoder 184 when the error e occurs in the partial MAC result Y. In the expression (3), MOD is the modulo operation, IN is the input data, [W_{U}|P_{U}] is the union of the weight data subset W_{U} and the parity bit P_{U}, α^{T} is a transpose of the encryption key α, and heavy dot (·) represents a dot product operation. As shown in the expression (3), IN·[D|P]+e]·α^{T} is a dividend, N is the divisor, and e·α^{T} is the remainder.

IN·[D|P]+e]·α^{T} MOD N≡e·α^{T} (3)

In some embodiments, the decoder 184 may determine the error with different polarities (i.e., a positive polarity error and a negative polarity error) based on the remainder of the expression (3). For example, when the remainder of the expression (3) is e·αT, there is a positive error in the partial MAC result Y; and when the remainder of the expression (3) is N−e·αT, there is a negative error in the partial MAC result Y. The decoder 184 may further determine a location of the error e based on the result of modulo result in the expression (3) and the encryption key α. When the location of the error e is determined, the decoder 184 may correct the error e in the partial MAC result Y to generate the decoded partial MAC result Y_cor. In some embodiments, the decoder 184 may correct the error e by adding or subtracting the error from the partial MAC Y, depending on the polarity of the error. For example, if there is a positive polarity error in the partial MAC Y, the decoder 184 may subtract 1 from the partial MAC Y; and if there is a negative polarity error in the partial MAC Y, the decoder 184 may add 1 to the partial MAC Y. It is appreciated that any suitable method for correcting the error e in the partial MAC result Y falls within the scope of the disclosure.

In some embodiments, after the encoder-decoder circuit 180 generates the decoded partial MAC result Y_cor for the m upper weight bits of the weight data W, the memory device 100 may continue accumulating partial MAC result for the subsequent weight bits (n−m subsequent weight bits) of the weight data W. After the MAC operation is performed to all bits of the weight data W, the memory device 100 outputs a complete MAC result.

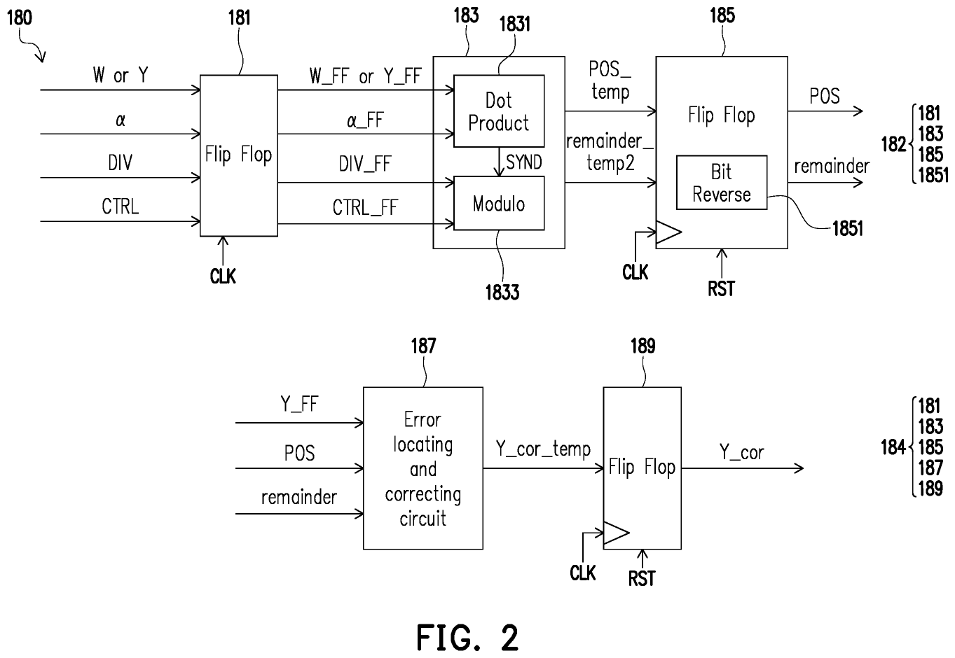

FIG. 2 illustrates a schematic diagram of the encoder-decoder circuit 180 of the memory device 100 in FIG. 1 in accordance with some embodiments. The encoder-decoder circuit 180 may include a first flipflop 181, a calculating circuit 183, a second flipflop 185, an error locating and correcting circuit 187 and a third flipflop 189. The encoder 182 of the encoder-decoder circuit 180 may include the first flipflop 181, the calculating circuit 183, the second flipflop 185 and the bit reverse circuit 1851. The decoder 184 of the encoder-decoder circuit 180 may include the first flipflop 181, the calculating circuit 183, the second flipflop 185, the error locating and correcting circuit 187 and the third flipflop 189. The first flipflop 181 and the calculating circuit 183 are shared to both encoder 182 and the decoder 184, and the bit reverse circuit 1851 of encoder 182 is merged to the third flipflop 185 of the decoder 184.

The first flipflop 181 may receive the weight data W or the partial MAC result Y, the encryption key α, the divisor DIV, and a control signal CTRL. In some embodiments, the control signal CTRL is configured to control the encoding operation and the decoding operation of the encoder-decoder circuit 180. When the control signal CTRL is in a first logic state (i.e., logic state of 0), the encoder-decoder circuit 180 performs the encoding operation; and when the control signal CTRL is in a second logic state (i.e., logic state of 1), the encoder-decoder circuit 180 performs the decoding operation. Referring to FIG. 1 and FIG. 2, the weight data W is inputted to the first flipflop 181 in the encoding operation, and the partial MAC result Y is inputted to the first flipflop 181 in the decoding operation.

In the encoding operation, the first flipflop 181 is configured to latch the weight data W, the encryption key α, the divisor DIV, and the control signal CLK to generate a latched weight data W_FF, a latched encryption key α_FF, a latched divisor DIV_FF, and a latched control signal CTRL_FF. The latching operation of the first flipflop 181 may be performed according to rising edges or falling edges of the clock signal CLK. The first flipflop 181 may output the latched weight data W_FF, the latched encryption key α_FF, the latched divisor DIV_FF, and the latched control signal CTRL_FF to the calculating circuit 183.

The calculating circuit 183 may include a dot-product circuit 1831 and a modulo circuit 1833 for performing a dot-product operation and a modulo operation on the latched weight data W_FF, the latched encryption key α_FF, the latched divisor DIV_FF. In the encoding operation, the dot-product circuit 1831 may receive the latched weight data W_FF and the latched encryption key α_FF, and the dot-product circuit 1831 may perform the dot-product operation on the latched weight data W_FF and the latched encryption key α_FF to generate a syndrome value. The modulo circuit 1833 may perform the modulo operation on the syndrome value and the latched divisor DIV_FF to generate a remainder value remainder_temp2. The calculating circuit 183 may output the remainder value remainder_temp2 to the bit reverse circuit 1851 of the second flipflop 185. The bit reverse circuit 1851 may generate the reminder according to the remainder value remainder_temp2. In some embodiments, each of bits of the remainder value remainder_temp2 is assigned to one bit of the remainder. Referring to FIG. 1 and FIG. 2, the remainder outputted by the second flipflop 185 in FIG. 2 may be referred to as the encoded weight data W_{EN} illustrated in FIG. 1. In this way, the encoder-decoder circuit 180 may perform the encoding operation to encode m upper weight bits of the weight data W according to the encryption key α to generate the encoded weight data W_{EN}.

In the decoding operation, the first flipflop 181 is configured to latch the partial MAC result Y, the encryption key α, the divisor DIV, and the control signal CTRL according to the clock signal CLK to generate a latched MAC result Y_FF, a latched encryption key α_FF, a latched divisor DIV_FF, and a latched control signal CTRL_FF. The first flipflop 181 may output the latched MAC result Y_FF, the latched encryption key α_FF, the latched divisor DIV_FF, and the latched control signal CTRL_FF to the calculating circuit 183. In the decoding operation, the dot-product circuit 1831 of the calculating circuit 183 may perform the dot-product operation on the latched MAC result Y_FF and the latched encryption key α_FF to generate a syndrome value SYND. The modulo circuit 1833 of the calculating circuit 183 may perform a modulo operation based on the syndrome value SYND and the latched divisor DIV_FF to generate a remainder value remainder_temp2. The calculating circuit 183 may further generate a value POS_temp which is determined according to the result of the modulo operation performed by the modulo circuit 1833. In the decoding operation, the second flipflop 185 may latch the value POS_temp according to the clock signal CLK and/or a reset signal RST to generate a value POS. In some embodiments, the value POS may indicate a polarity of the error detected in the partial MAC result Y. For example, if the value POS is “1”, the detected error has the positive polarity; and if the value POS is “0”, the detected error has the negative polarity.

In the decoding operation, the error locating and correcting circuit 187 may receive the latched MAC result Y_FF, the value POS and the remainder. The error locating and correcting circuit 187 is configured to locate the error in the latched MAC result Y_FF according to the latched MAC result Y_FF, the value POS and the remainder. The error locating and correcting circuit 187 may further correct the located error in the latched MAC result Y_FF to generate a temporary corrected MAC result Y_cor_temp. The third flipflop 189 may latch the temporary corrected MAC result Y_cor_temp according to the clock signal CLK and/or the reset signal RST to generate the decoded MAC result Y_cor. In this way, the encoder-decoder circuit 180 may perform the decoding operation to detect an error occurring in the MAC result Y_FF of the MAC operation.

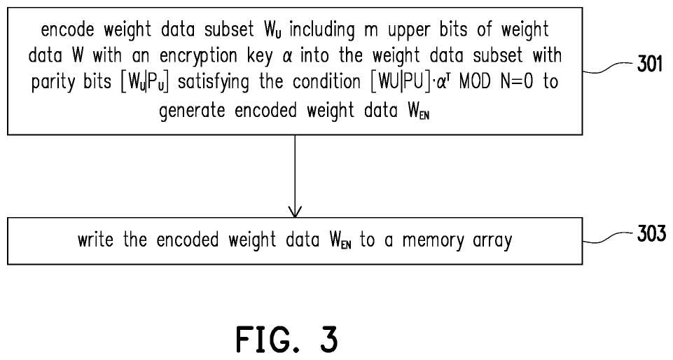

FIG. 3 illustrates a flowchart diagram of an encoding process of a memory device (i.e., memory device 100 in FIG. 1) in accordance with some embodiments. In block 301, a weight data subset W_{U} including m upper weight bits of weight data W is encoded with an encryption key α into a union [W_{U}|P_{U}] of the weight data subset W U and parity bit P_{U} to generate encoded weight data W_{EN}. The encoding of the weight data subset W_{U} satisfies a condition of [WU|PU]·α^{T} MOD N=0, in which MOD represents a modulo operation, [W_{U}|P_{U}] represents the union of the weight data subset W_{U} and parity bit P_{U}, and α^{T} represents the transpose of the encryption key α. In some embodiments, a bit width of the weight data W is n, a bit width of the weight data subset W_{U} is m, and a bit width of the parity bits P_{U} are k, in which m, n and k are positive integers, and m is less than n.

In block 302, the encoded weight data W_{EN} is written to a memory array of memory device. In some embodiments, the encoded weight data W_{EN} is represented as [W|P_{U}], in which m upper weight bits of the weight data W is encoded with the encryption key α, and the remaining n−m weight bits of the weight data W is not encoded with the encryption key α. In this way, the encoding operation is capable of selectively encoding m upper weight bits (or more significant bits) of the weight data W. In addition, since a MAC operation is performed on the encoded weight data and the input data, a result of the MAC operation is protected by the encoding operation. Furthermore, because the encoding operation emphasizes on protecting the selected m upper weight bits of the weight data W, an error tolerance of a neural network application that utilizes the encoding operation is improved.

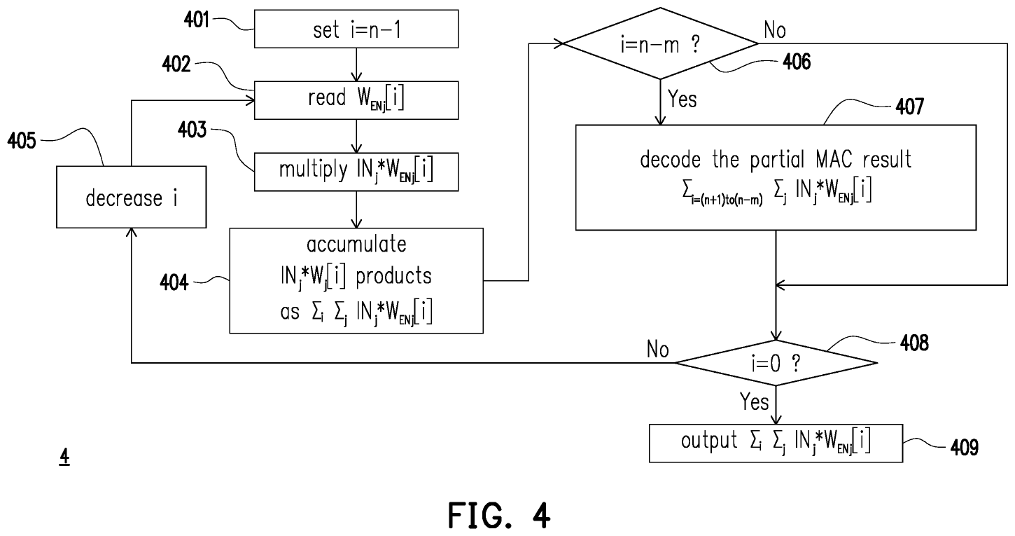

FIG. 4 illustrates a flowchart diagram of a decoding process of a memory device (i.e., memory device 100 in FIG. 1) in accordance with some embodiments. In block 401, an iterative variable i is set to n−1, in which n is the bit width of the encoded weight data W_{EN}. In blocks 402 to 404, each weight bit W_{ENj}[i] of the encoded weight data W_{EN} corresponding to the iterative variables i and j is read out (block 402); the weight bit W_{ENj}[i] is multiplied with the input data INⱼ (block 403) to obtain a product INⱼ*W_{ENj}[i]; and a product INⱼ*W_{ENj}[i] is accumulated to a partial MAC result ΣᵢΣⱼ INⱼ*W_{ENj}[i].

In block 406, the decoding process determines whether the iterative variable i is equal to n−m. In other words, the block 406 may determine whether MAC operation has performed the m upper weight bits W_{EN}[n−1] to W_{EN}[n−m]. The partial MAC result of the m upper weight bits W_{EN}[n−1] to W_{EN}[n−m] and the input data IN is represented as Σ_{i=(n-1) to (n-m)}ΣⱼINⱼ*W_{ENj}[i] If the iterative variable i is not equal to n−m (No in block 406), the decoding process proceeds to block 408. If the iterative variable i is equal to n−m (Yes in block 406), the decoding process proceeds to block 407. In block 407, the decoding process is configured to decode the partial MAC result Σ_{i=(n-1) to (n-m)}IN*W W_{EN}[i]. The decoding process may further detect whether there is an error in the partial MAC result Σ_{i=(n-1) to (n-m)}ΣⱼINⱼ*W_{ENj}[i], and correct the error in the partial MAC result Σ_{i=(n-1) to (n-m)}ΣⱼINⱼ*W_{ENj}[i] if the error is detected in block 407.

In some embodiments, the decoding process detects the error in the partial MAC result based on a result of a modulo operation performed by the encoder-decoder circuit (i.e., the encoder-decoder circuit 184 in FIG. 1) on the partial MAC result and the encryption key α. An exemplary of the modulo operation performed by the encoder is shown in expression (3). The encoder-decoder circuit may determine a location of the error e by comparing the result of modulo result in the expression (3) with the encryption key α. When the error e is determined, the encoder-decoder circuit 184 may correct the error in the partial MAC result to generate the decoded partial MAC result.

In block 408, the decoding process determines whether the iterative variable i is equal to zero. If iterative variable i is not equal to zero, the iterative variable i is decreased by one (block 405), and the decoding process returns to block 402 to continue the accumulation of MAC result for the subsequent weight bits of the weight data W_{EN} (blocks 402 to 408). In other words, a result of the MAC operation on the subsequent weight bits of weight data and the input data is accumulated to the decoded partial MAC result to generate a complete MAC result ΣᵢΣⱼINⱼ*W_{ENj}[i]. If iterative variable i is equal to zero in block 408, the decoding process outputs the corrected MAC result ΣᵢΣⱼINⱼ*W_{ENj}[i].

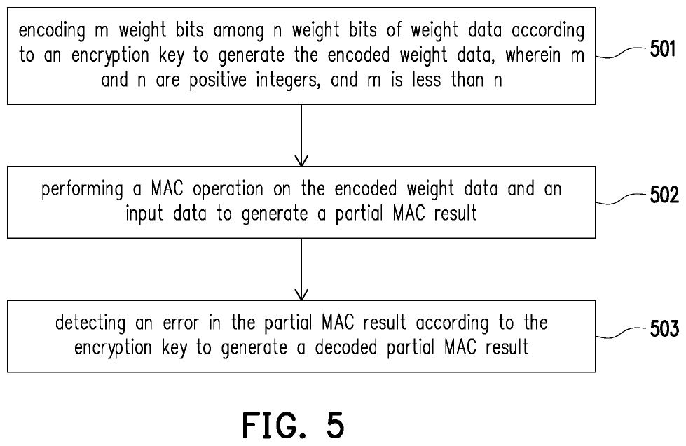

FIG. 5 illustrates a flowchart diagram of a flowchart diagram of an operating method of a memory device in accordance with some embodiments. The memory device may be the memory device 100 illustrated in FIG. 1. In block 501, m weight bits among n weight bits of weight data are encoded according to an encryption key to generate the encoded weight data, wherein m and n are positive integers, and m is less than n. In block 502, a MAC operation is performed on the encoded weight data and an input data to generate a partial MAC result. In block 503, an error in the partial MAC result is detected according to the encryption key to generate a decoded partial MAC result.

In accordance with some embodiments, a memory device includes an encoder-decoder circuit that is capable of selectively encoding a portion of a data sequence (i.e., weight data) rather than encoding all bits of the data sequence. The encoder-decoder circuit may encode m upper weight bits (or m most significant bits) of the weight data according to an encryption key to generate an encoded weight data. In this way, the memory device may focus an error protection capability to important bits of the weight data, and an error tolerance of the memory device is improved. In addition, the memory device may read out the encoded weight data, and perform the MAC operation on the encoded weight data and an input data to generate a partial MAC result. Since the encoded weight data is protected, the partial MAC result that is generated based on the encoded weight data is also protected. The partial MAC result may be encoded by the encoder-decoder circuit to generated a decoded partial MAC result. After the decoded partial MAC result is obtained, the MAC operation may be performed for the subsequent weight bits of the weight data and a partial MAC result of the subsequent weight bits may be accumulated to the decoded partial MAC result to generate a complete MAC result. Furthermore, the encoder-decoder circuit of the memory device may include a merge of an encoder and a decoder. In other words, components of the encoder may be merged to the components of the decoder to form the encoder-decoder circuit. The encoding operation and the decoding operation of the encoder-decoder circuit is controlled according to a control signal. Since the components of the encoder and decoder are merged, an occupied area of the encoder and the decoder is reduced.

In accordance with some embodiments, a memory device includes a memory array, a multiply-accumulate (MAC) circuit and an encoder-decoder circuit. The memory array stores encoded weight data. The MAC circuit performs a MAC operation on the encoded weight data and an input data to generate a partial MAC result. The encoder-decoder circuit includes an encoder and a decoder, and the encoder is configured to encode m weight bits among n weight bits of weight data according to an encryption key to generate the encoded weight data, wherein m and n are positive integers, and m is less than n. The decoder is configured to detect an error in the partial MAC result according to the encryption key to generate a decoded partial MAC result.

In accordance with some embodiments, a memory device includes a memory array, an encoder, a write driver, a multiply-accumulate (MAC) circuit, and decoder. The memory array stores encoded weight data, and the encoder encodes m weight bits among n weight bits of weight data according to an encryption key to generate the encoded weight data, wherein m and n are positive integers, and m is less than n. The write driver is coupled to the encoder and is configured to receive the encoded weight data from the encoder and write the encoded weight data to the memory array. The sense amplifier is coupled to the memory array and is configured to read the encoded weight data from the memory array. The MAC circuit performs a MAC operation on the encoded weight data and an input data to generate a partial MAC result. The decoder is coupled to the MAC circuit and is configured to detect an error in the partial MAC result according to the encryption key to generate a decoded partial MAC result.

In accordance with some embodiments, an operating method of a memory device comprising a memory array, an encoder-decoder circuit is introduced. The operating method includes steps of encoding m weight bits among n weight bits of weight data according to an encryption key to generate the encoded weight data, wherein m and n are positive integers, and m is less than n; writing the encoded weight data to the memory array; reading the encoded weight data from the memory array; performing a MAC operation on the encoded weight data and an input data to generate a partial MAC result; and detecting an error in the partial MAC result according to the encryption key to generate a decoded partial MAC result.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A memory device, comprising:
a memory array, storing encoded weight data;
a multiply-accumulate (MAC) circuit, performing a MAC operation on the encoded weight data and an input data to generate a partial MAC result; and
an encoder-decoder circuit, comprising:
an encoder, encoding m weight bits among n weight bits of weight data according to an encryption key to generate the encoded weight data, wherein m and n are positive integers, and m is less than n; and
a decoder, detecting an error in the partial MAC result according to the encryption key to generate a decoded partial MAC result.

2. The memory device of claim 1, wherein the m weight bits are m most significant bits of the weight data.

3. The memory device of claim 1, wherein the encoder of the encoder-decoder circuit is configured to encode the m weight bits among the n weight bits of the weight data such that a result of a modulo operation on the encoded weight data and the encryption key is equal to zero.

4. The memory device of claim 3, wherein the decoder of the encoder-decoder circuit is configured to:
receive the partial MAC result from the MAC circuit;
detect the error in the partial MAC result according to a result of a modulo operation performed on the partial MAC result and the encryption key; and
locate a location of the error in the partial MAC result according to a comparison of the encryption key with the result of the modulo operation performed on the partial MAC result and the encryption key.

5. The memory device of claim 4, wherein the decoder of the encoder-decoder circuit determines that the error occurs in the in the partial MAC result in response to determining that the result of the modulo operation performed on the partial MAC result and the encryption key is a non-zero value.

6. The memory device of claim 1, wherein
the n weight bits of the weight data comprise the m weight bits and subsequent weight bits, and
the MAC circuit is further configured to:
perform the MAC operation on the input data and the subsequent weight bits; and
accumulate a result of the MAC operation on the input data and the subsequent weight bits to the decoded partial MAC result to generate a complete MAC result.

7. The memory device of claim 1, wherein the encoder-decoder circuit is configured to:
receive a control signal;
perform an encoding operation when the control signal is in a first logic state, and
perform a decoding operation when the control signal is in a second logic state.

8. The memory device of claim 7, wherein the encoder-decoder circuit comprises:
a first flipflop circuit, latching the encryption key, the weight data, a divisor, and a control signal to generate a latched encryption key, a latched weight data, a latched divisor, and a latched control signal;
a calculating circuit, coupled to the first flipflop circuit, performing a dot-product operation and a modulo operation according to the latched weight data, the latched encryption key, the latched divisor and the latched control signal to generate a syndrome value and a remainder value;
a second flipflop circuit, comprising a bit reverse circuit that generates the encoded weight data according to the remainder value in the encoding operation;
an error locating and correcting circuit, locating the error in the partial MAC result to generate the decoded partial MAC result in the decoding operation; and
a third flipflop circuit, latching the decoded partial MAC result in the decoding operation.

9. The memory device of claim 1, further comprising:
a write driver, coupled to the encoder-decoder circuit, receiving the encoded weight data from the encoder-decoder circuit and writing the encoded weight data to the memory array; and
a sense amplifier, coupled to the memory array, reading the encoded weight data from the memory array and outputting the encoded weight data to the MAC circuit.

10. A memory device, comprising:
a memory array, storing encoded weight data;
an encoder, encoding m weight bits among n weight bits of weight data according to an encryption key to generate the encoded weight data, wherein m and n are positive integers, and m is less than n;
a write driver, coupled to the encoder, receiving the encoded weight data from the encoder and writing the encoded weight data to the memory array;
a sense amplifier, coupled to the memory array, reading the encoded weight data from the memory array;
a multiply-accumulate (MAC) circuit, performing a MAC operation on the encoded weight data and an input data to generate a partial MAC result;
a decoder, coupled to the MAC circuit, detecting an error in the partial MAC result according to the encryption key to generate a decoded partial MAC result.

11. The memory device of claim 10, wherein the m weight bits are m most significant bits of the weight data.

12. The memory device of claim 10, wherein the encoder of the encoder-decoder circuit is configured to encode the m weight bits among the n weight bits of the weight data such that a result of a modulo operation on the encoded weight data and the encryption key is equal to zero.

13. The memory device of claim 10, wherein the decoder of the encoder-decoder circuit is configured to:
receive the partial MAC result from the MAC circuit;
detect the error in the partial MAC result according to a result of a modulo operation performed on the partial MAC result and the encryption key; and
locate a location of the error in the partial MAC result according to a comparison of the encryption key with the result of the modulo operation performed on the partial MAC result and the encryption key.

14. The memory device of claim 10, wherein
the n weight bits of the weight data comprise the m weight bits and subsequent weight bits, and
the MAC circuit is further configured to:
perform the MAC operation on the input data and the subsequent weight bits; and
accumulate a result of the MAC operation on the input data and the subsequent weight bits to the decoded partial MAC result to generate a complete MAC result.

15. The memory device of claim 10, wherein:
the encoder and the decoder are merged into an encoder-decoder circuit, and
the encoder-decoder circuit is configured to:
receive a control signal;
perform an encoding operation when the control signal is in a first logic state, and
perform a decoding operation when the control signal is in a second logic state.

16. The memory device of claim 15, wherein the encoder-decoder circuit comprises:
a first flipflop circuit, latching the encryption key, the weight data, a divisor, and a control signal to generate a latched encryption key, a latched weight data, a latched divisor, and a latched control signal;
a calculating circuit, coupled to the first flipflop circuit, performing a dot-product operation and a modulo operation according to the latched weight data, the latched encryption key, the latched divisor and the latched control signal to generate a syndrome value and a remainder value;
a second flipflop circuit, comprising a bit reverse circuit that generates the encoded weight data according to the remainder value in the encoding operation;
an error locating and correcting circuit, locating the error in the partial MAC result to generate the decoded partial MAC result in the decoding operation; and
a third flipflop circuit, latching the decoded partial MAC result in the decoding operation.

17. An operating method of a memory device, the operation method comprising:
encoding m weight bits among n weight bits of weight data according to an encryption key to generate the encoded weight data, wherein m and n are positive integers, and m is less than n;
performing a MAC operation on the encoded weight data and an input data to generate a partial MAC result; and
detecting an error in the partial MAC result according to the encryption key to generate a decoded partial MAC result.

18. The operating method of claim 17, wherein
the m weight bits are m most significant bits of the weight data, and
the m weight bits among n weight bits of weight data are encoded such that a result of a modulo operation on the encoded weight data and the encryption key is equal to zero.

19. The operating method of claim 17, wherein detecting the error in the partial MAC result according to the encryption key comprises:
receiving the partial MAC result from the MAC circuit;
detecting the error in the partial MAC result according to a result of a modulo operation performed on the partial MAC result and the encryption key; and
locating a location of the error in the partial MAC result according to a comparison of the encryption key with the result of the modulo operation performed on the partial MAC result and the encryption key.

20. The operating method of claim 17, wherein
the n weight bits of the weight data comprise the m weight bits and subsequent weight bits of the weight data, and
the operating method further comprising:
performing the MAC operation on the input data and the subsequent weight bits of weight data; and
accumulating a result of the MAC operation on the input data and the subsequent weight bits of weight data to the decoded partial MAC result to generate a complete MAC result.
